(19) United States
(12) Patent Application Publication
(10) Pub. No.: US 2018/0252506 A1
(43) Pub. Date: Sep. 6, 2018

(54) Electrode-Free Plasma Lamp Optical Disruption

(71) Applicant: Loren P. Hoboy, Avondale, AZ (US)

(72) Inventor: Loren P. Hoboy, Avondale, AZ (US)

(21) Appl. No.: 14/587,262

(22) Filed: Dec. 31, 2014

Related U.S. Application Data
(63) Continuation-in-part of application No. 14/495,748, filed on Sep. 24, 2014, now abandoned.

(51) Int. Cl. F41H 13/00; H01J 65/04

(52) U.S. Cl. CPC F41H 13/0087; F41H 13/0075; F41H 13/0068; H01J 65/04

(57) ABSTRACT

A method and device for interfering with or reducing the activity of one or more targets by over-stimulating the targets optic nerve with a high intensity incoherent light beam (HIILB) emanating from an electrode-free plasma (EFS) lamp. The steps of the method include providing a HIILB from an EFS lamp housed in a device and directing the beam at the one or more targets when facing the device. The device includes an outer housing with a head portion having a window opening for transmitting a HIILB, an optical system mounted in the head portion facing the window, one or more EFP lamps mounted at the focus of the optical system to collimate the light towards the window, an electrical circuit for driving the one or more lamps wherein the electrical circuit has an energy source and a plasma lamp induction coupling to the energy source for operation.

### CROSS-REFERENCE TO RELATED APPLICATIONS

This application is a continuation in part of patent application Ser. No. 14/495,748 filed 24 Sep. 2014

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### TECHNICAL FIELD

The present invention relates generally to a directed energy incoherent electrodeless plasma light source, non-lethal energy weapon for temporary human and animal Optical disruption and personal protection, and is particularly concerned with stationary, mobile mounted, vessel mounted, aircraft mounted, portable and handheld searchlights, spotlights, and flashlights for used for near distance and long distance engagement resulting in illumination, warning disruption, repelling, suppression and Optical disruption of the human and animal aggressor(s).

### BACKGROUND OF THE INVENTION

In recent years, the use of non-lethal effector weapons and personal protection devices have proven progressively more effective in coping with adversaries in an enforcement, corrections, security personnel, and military personnel, and personal security. The goal of protection personnel in most confrontations is to use the least amount of force necessary to control a situation. Avoidance of collateral damage is increasingly vital for public policy reasons. Escalating levels of force response starts with observation, progressing to visual and verbal warnings, distraction, use of non-lethal force avoiding lethal force if possible. The likelihood of permanent injury or death increases as force response level increases. Thus security personnel would like a measured response that assures their personal safety yet minimizes the harm to an adversary and by-standers to the maximum extent attainable.

The greater distance the aggressor is from the enforcement personnel, the more time enforcement personnel have to react and make a measured non-lethal response to minimize collateral damage to both the aggressor and to the enforcement personal. The non-lethal effectors ideally should offer both individual and group control options.

Prior development of light directed energy weapons include:

### Laser Dazzlers:

Ultra-bright light laser sources utilizing coherent light claim to control escalation of confrontations between security personnel and adversaries. Laser dazzlers work by temporarily blinding a subject using a green laser with no risk of killing the person. Most models built for military use are designed to work at distances of 300 to 500 meters during the day and are reported to work up to a kilometer at night. Examples, of such devices are described in U.S. Pat. Nos. 5,685,636; 6,007,218; and 7,040,780.

Laser optical disruption companies claim operation at 1,000-1,600 feet during the day and 3,200 feet at night. At 40 meters, the intense beam of a 200-milliwatt laser can permanently damage eyes. Some permanent eye damage has been reported in the press from non-lethal lasers used by the military. The primary disadvantage of coherent light lasers is that they produce a very narrow single spectrum of light such that the intensity is difficult to manage to avoid permanent eye damage. Human eyes are ill adapted for natural protection against single wave length outputs of coherent light like lasers and the human eye is highly susceptible to damage from laser beams.

On the other hand a human is well adapted to responding safely to incoherent light in the broad spectrum of sunshine. This gives incoherent light a safety advantage over a laser beam.

The costs of laser technologies are comparatively higher than other non-lethal handheld light technologies. Further, lasers are susceptible to counter measures such as wave specific eye protection. The coherent single laser wavelength has the added disadvantage of not covering all the wavelengths correspond to the shift in the eye's sensitivity from day to night between rods and cones. In addition, lasers are International Traffic in Arms Regulations (ITAR) export controlled and export is highly restricted.

### LED/Flash Lamp and Strobes:

In October 2007 an article title “High-intensity crime fighting with next-generation strobe lights” by Ralph Mroz appeared in Police & Security News: “The latest technology is strobing lights . . . .” What benefits does strobing provide? Here are some of the claims made: 1) causes disorientation and blinding; 2) causes peripheral vision disabling; 3) limits the ability to get accurate fire on you; and 4) induces fear and/or indecision . . . . They will also be blinded by the very bright white light that's strobing—we're all familiar with the blinding effect of 60 or more lumens in the eyes of a suspect. The strobe adds disorientation to the blinding. The tactical advantages of this are obvious.”

A more recent apparatus is U.S. Pat. No. 7,180,426 a multicolor strobing LED device to simulate full spectrum light combined with a strobe effect. It has an effective range under 30 feet.

Examples, of other light emitting diode (LED) and high intensity discharge (HID) devices are described in U.S. Pat. Nos. 8,710,742; 8,419,213; 7,909,484; 7,500,763; and 6,190,022.

### Short Arc Optical Disruption:

Historically some arc lamp searchlights are bright enough to cause permanent or temporary blindness, and they were used to dazzle the crews of bombers during World War II. The canal defense light (CDL) was a British “secret weapon” of the Second World War ca. 1943 and was used on the battle field. It was based upon the use of a powerful carbon-arc searchlight mounted on a tank. A row of tanks (4) would target the field of battle at up to 1000 yards at a 19-degree angle, driving forward and opening and closing a light shutter to disrupt the enemy. It was intended to be used during night-time attacks, when the light would allow enemy positions to be targeted. A secondary use of the light was to dazzle and disorient enemy troops, making it harder for them to return fire accurately.

U.S. Pat. No. 7,866,082 teaches a method for incapacitating one or more target individuals comprising the steps of: providing a high intensity incoherent light beam emitting device, wherein the device specifically comprises a short-arc lamp; Examples, of non-lethal short arc lamp inventions are described in U.S. Pat. Nos. 7,497,586; 7,866,082; 8,567,980; and 8,721,105.

The advantage of a short arc lamp output is that it can be focused to operate at much greater distances than LED, or HID light sources. Drawbacks of the method and apparatus that is the subject of U.S. Pat. Nos. 7,497,586 and 7,866,082 include high power consumption (15 lumen/Watt (lm/W)), 5% conversion of energy to light, artifacts in the projected light beam, such as shadows resulting from the electrodes and cathode and focus efficiency is highly susceptible to manufacturing tolerance concerns and heat expansion during operations necessitating continual focal length adjustment.

Short arc lamps and other lamps with electrodes must deal with the phenomenon of the “black-hole” in the center of the beam which results from shadows, artifacts in the light beam caused by the electrode, cathode terminal, and wires in the light stream, as well as plasma ball shape distortion caused by the electrodes and wide manufacturing tolerances. Further there can be light loss with short arc lamps due to rear hole in reflectors, since electrical wires and the lamp need to penetrate the reflector surface.

With high energy consumption of short-arc lamps, battery size and weight is a design drawback for portable applications.

Useful lamp life of short arc lamps is limited to 400-1000 hours. Further, due to electrode erosion of the short arc lamp spectral output can be expected to change as the lamp envelope is blackened. The only solution is to change the short arc lamp frequently. In addition, short arc lamps are generally large, approximately 100 cm by 20 cm for handheld or mobile devices, making them difficult and cumbersome to design around.

### Flash Bang Devices/Projectile Sun Devices:

A stun grenade, also known as a flash grenade or flash bang, is a non-lethal explosive device used to temporarily disorient an enemy's senses. It is designed to produce a blinding flash of light and intensely loud noise “bang” of greater than 170 decibels (dB) without causing permanent injury. It was first developed in the 1960s. The flash produced momentarily activates all photoreceptor cells in the eye, depriving the target of vision for about five seconds.

Examples, of such devices are described in U.S. Pat. Nos. 8,161,883; 8,113,689; 7,191,708; and 6,767,108.

These types of devices are used in contained spaces. Collateral damage is a high risk. The loud blast of these devices can cause temporary or permanent loss of hearing and loss of balance. Although stun grenades are designed to be non-lethal, several injuries have been reported. The disadvantage of these devices is that they can blind the user as well as bystanders and dispensing methods may present fire or explosive hazards. Some deaths and fire have been attributed to their use. Specifically, phosphorus grenades that explode on impact, creating lots of noise, bright white light, have the drawback that they produce high levels of heat capable of inflicting severe burns.

### Electro-Muscular Disruption:

There are reported risks associated with electrical shock and guns outfitted with rubber bullets from injury to death as reported in the press. The use of non-lethal light avoids the potential risk of death due to strong electrical shock devices. There are those critics that consider this type of technology to be inflicting pain to gain compliance in violation of “United Nations Convention against Torture and Other Cruel, Inhuman or Degrading Treatment or Punishment (the “Torture Convention”) adopted 1987.”

This issue remains a concern for certain non-lethal weapons “The United States government acknowledges continuing allegations of specific types of abuse and ill-treatment in particular cases, the existence of areas of concern in the context of the criminal justice system, and obstacles to full achievement of the goals and objectives of the Convention. These include allegations and instances (and in some cases even patterns or practices) of: —police abuse, brutality and unnecessary or excessive use, of force, including inappropriate use of devices and techniques such as tear gas and chemical (pepper) spray, tasers or “stun guns”, stun belts, police dogs, handcuffs and leg shackles; . . . ” “Convention against Torture and Other Cruel, Inhuman or Degrading Treatment or Punishment”, published by the Committee Against Torture Consideration of Reports Submitted by State Parties Under Article 19 of the convention . . . ” (see page 21, paragraph 70).

Therefore, there is a need for a device that significantly reduces the risk of permanent injury and increases the effectiveness of interfering with or reducing the activity of one or more target individuals as compared to current methods. In particular, a device that emits non-lethal incoherent light and methods of using the same, wherein the lamp has a manufacturer's rated lamp life of 10,000-50,000 hours as compared to short arc lamps having a manufacturer's rated lamp life of 500-2,000 hours, emits a more consistent spectral output by eliminating the presence of an electrode as well as eliminating erosion that can M occur with short arc lamps causing the lamp envelope to blacken, reduces the cost of production and maintenance because the increased life expectancy eliminates the need to change the lamp as frequently as with short arc lamps, is smaller, approximately 3 mm by 10 mm, as compared to short arc lamps that are 100 cm by 20 cm in size enabling the construction of a compact and more rugged device, and produces a light energy that does not injure the target in compliance with the intent of United Nations international agreement adopted in 1987 by 165 international countries.

### SUMMARY OF THE INVENTION

The present invention is a non-lethal, less-than-lethal, or less-lethal hand-held, mobile or stationary light beam that uses incoherent visible white light from an electrode-free plasma (EFP) light source to illuminate, warn, and temporarily disorient, visually impair, stun, optically disorient, reduce the cognitive abilities of, muscular disruption, or otherwise control and limit the actions of one or more persons, assailants, perpetrators, intruders, or adversaries, without causing permanent injury.

It is an object of this invention to provide non-lethal, non-eye-damaging security devices based on intense light and, more particularly to provide non-lethal, non-damaging security devices using incoherent light from an electrodeless light source (lamp) to cause visual impairment and disorientation through illumination by focused bright, visible light beams to achieve greater operating distances, with less energy consumption and less optical distortion for day and night operations.

This invention is a non-lethal light directed energy weapon and non-lethal effector method for observing, suppressing, stunning, disabling, optical disrupting and control of humans and animals using a device, producing incoherent visible light, consisting of constant or modulated EFP output source, or induction plasma lamp of sufficient intensity and focus to cause temporary optical disruption of a person or animal (target) for a period of time when illuminated by the beam without causing permanent physical harm at the selected engagement distance.

The method utilizes Electrode Free Plasma (EFP) lamps, a type of gas discharge lamp, excited by electromagnetic waves, which concentrates waves into a waveguide or directly, which energize light-emitting plasma in a filled bulb positioned within the wave field. The electromagnetic waves include Radio (RF) as well as HF energy (microwaves) generated with a magnetron to power the plasma light source or they may be light-emitting plasma energized in a filled bulb positioned within the field energized by a laser beam.

The most significant advantage of an electrodeless light source over other incoherent light sources is to the additional flexibility present to optical configurations in directing light to the target. The designer no longer needs to work around the shadow cast (black hole) caused by electrodes and cathode wires in the projected beam path. The light ray of this EFP output is almost a perfect pinpoint light source, as small as 1 to 3 mm, allowing it to be focused and collimated as needed for the applications without needing to design around unwanted artifacts. There is a four to ten-fold improvement in lumens per Watt output when using EFP lamps for illumination and Optical Disruption, which allows for smaller battery packs and lighter weight portable apparatuses.

The method utilizes an EFP lamp generally mounted behind a lens or within a reflector which may be combined with an optical system of mirrors, lens or combinations and configurations where the small plasma ball generated is optimally located at the focal point of the lens or reflector and positioned so as to collimate light from the lamp through the window opening and direct the light beam towards the target(s) at near or long range at the desired discharge angle. An adjustable or fixed mounting base for the light source or optical array or components thereof can allow the position of the lens, reflector and optics to be adjusted until the optimum light focus is reached for light beam intensity delivery to the target. The method may use one or more EFP devices in an array to target aggressors at greater distances or in a wider field of engagement.

The apparatuses of this invention will find use for law-enforcement, military, private security, first-responders, maritime and personal security. They may be designed for handheld devises, vehicle and boat mounted, stationary, ship-board, and other uses. Example apparatus configurations of the method are shown in FIG. 8 through FIG. 11.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### DESCRIPTION OF THE FIGURES

The present invention will be better understood from the following detailed description of a preferred embodiment of the invention, taken in conjunction with the accompanying drawings, in which like reference numerals refer to like parts.

FIG. 1: Retinal response of human eye rods and cones to light.

FIG. 2: Spectral output of an EFP lamp filed with argon and metals halides.

FIG. 3: Graphic drawing of an EFP lamp mounted in resonator.

FIG. 4: EFP lamp envelopes.

FIG. 5: EFP lamp startup sequence steps 1-3.

FIG. 6: Diagram of the elements of a typical EFP lamp apparatus.

FIG. 7: Inline EFP lamp apparatus with collimation reflector.

FIG. 8: Inline EFP lamp apparatus with collimation reflector and internal optics.

FIG. 9: EFP lamp apparatus with collimation reflector and internal optics mounted on a tilt pan.

FIG. 10: Right angle EFP lamp apparatus with collimation reflector and internal optics.

FIG. 11: Array of eight EFP lamp apparatus mounted on a tilt pan.

FIG. 12: Parabolic reflector surface with an internally mounted refractive surface.

FIG. 13: Refractor on the outside lens where the collimating lens has four types of surfaces.

FIG. 14: Refractor on the inside where the collimating lens has four surface types.

FIG. 15: Fresnel lens.

FIG. 16: (A) Luminance flux disruption pattern-electrodeless plasma lamp and (B) Luminance flux disruption pattern-short arc lamp.

FIG. 17: (A) Xenon short arc lamp spectrum and (B) EFP Lamp spectrum.

FIG. 18: is a diagrammatic representation of a preferred embodiment wherein the device consists of an assemble of a 135 W Topanga APL250-4000 RF solid state Driver RF driver, coaxial connector cable, Topanga APL 250-4000SF resonator, and APL250-4000 plasma bulb, a quartz lamp embedded in a ceramics resonator, and associated micro-controller interface and powered with a lithium-ion 24-volt rechargeable battery capable of delivering a minimum of 10 amps.

### DETAILED DESCRIPTION

### Definitions

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “electrode-free plasma” (EFP) as used here also refers to and includes “electrodeless plasma”, “electrodeless lamp”, “induction light” and “electrodeless plasma light” output source, “gas discharge lamp”, “inductive plasma lamps” and inductive plasma light, including light emitting plasma, high efficiency plasma, laser-driven plasma light and electrode-free high-intensity discharge (HID) lamps, where there is no electrode on the inside of the lamp envelope.

The terms “radio wave” and “radio frequency” (RF) as used herein refer to electromagnetic waves with a frequency from 300 MHz to 3,000 GHz and include microwaves between 300 MHz and 300 GHz.

The terms “electromagnetic wave” as used herein refers to electromagnetic waves including gamma-rays, x-rays, ultraviolet light (UV), visible light, infrared light (IR), microwave and radio wave.

The term “optical disrupter or optical disruption” as used herein refers to the capability of limiting the actions of a target by causing vision impairment, neural disruption, muscular disruption, motor skill disruption, disorientation, vertigo, nausea, temporary blindness, night blindness, snow blindness, flash blindness, glare, decrement in visual effectiveness, reducing cognitive abilities, loss of balance, psychophysical effects, indecision, vision loss, peripheral vision loss, disruption of fine and gross motor skills which can also be described as suppression, disabling, stunning, and dazzling.

The term “non-lethal” as used herein shall apply to the meaning of that term as generally defined and used by those skilled in the art, those in the military and includes the terms “less-lethal” and “less-than-lethal” as used by the law enforcement, U.S. Department of Justice and security personnel.

The term “incoherent light” as used herein refers to light that is not produced from a coherent or single wave length light source such as a laser or LED. Ordinary light from the Sun and plasma lamps consists mainly of light waves of many different wavelengths and is considered incoherent light which tends to be randomly phased as opposed to “coherent light” wherein the waves are in phase with each other as is generally found with laser light.

The term “range finder” as used herein is any means for estimating, approximating or determining the distance from the plasma source of an apparatus of this invention to the target. Examples of such measuring devices include electronic distance meters, and IR distance meters, laser range finder (LRF), radio waves (RF) distance meters, radar and sound waves measuring devices.

The term “means for determining light level” as used herein refers to any means for estimating, approximating or determining the background light level or a means for determining the light levels at the target. One example of such a device is a directional light meter.

The term “means for triggering” as used herein refers to any method that may be employed to release a beam of light from the device of the present invention.

The term “glare” as used herein refers to an effect of reduced visibility condition due to a bright source of light in a person's field of view. It is a temporary effect that disappears as soon as the light source is extinguished, or directed away from the subject. The light source will emit light in the human visible portion of the spectrum and must be continuous or flashing to maintain the reduced-visibility glare effect. The degree of visual impairment due to glare depends on the brightness of the M light source relative to ambient lighting conditions. The disadvantage is that the aggressor is still capable of inflicting harm and can still see.

The term “flashblinding” and “flashblindness” as referred to herein is a temporary loss or reduction so as to reduce visibility that continues after a bright source of light is switched off. It appears as a spot or afterimage in one's vision that interferes with the ability to see in some or any direction. The nature of this impairment makes it difficult for a person to discern objects, especially small, low-contrast objects or objects at a distance. The duration of the visual impairment can range from a few seconds to several minutes. The visual impairment depends upon the brightness of the initial light exposure and the person's visual needs. The major difference between the flashblind effect and the glare effect is that visual impairment caused by flashblind remains for a short time after the light source is extinguished, whereas visual impairment due to the glare effect does not.

The term “target” and “aggressor” and “adversaries” as referred to herein is an individual or group of individuals or animals, upon which the light beam from the devices and methods of this invention are intended to be applied.

The present invention is a method for suppressing, stunning, disabling, optical disruption and control of humans and animals using a device, with an incoherent visible light, consisting of constant or modulated EFP light output source, and induction plasma light of sufficient intensity and focus to cause temporary optical disruption of a person or animal (target) for a period of W time when illuminated by the beam without causing permanent physical harm at the selected engagement distance.

The apparatuses of this invention will find applications in law-enforcement, military, private security, first-responders, and maritime and personal security applications. Embodiments of the apparatuses of this invention include but are not limit to handheld devises, vehicle and boat mounted, stationary or fixed perimeter, ship-board. Non-lethal applications will include crowd control and anti-piracy and terrorism counter measure.

The method utilizes EFP lamps, a gas discharge lamp, which can be energized by electromagnetic waves, which energizes a light-emitting plasma in a bulb positioned in the field, to excite the plasma light source (FIG. 5) for control of humans and animals.

The method may utilize the EFP lamp mounted within a reflector in combination with an optical system of reflectors, mirrors, lens or combinations and configurations thereof so that the small plasma ball generated is optimally located to the focal point of the optical system and positioned so as to collimate light from the lamp through the window opening and direct the light beam towards the target(s) at near or long range distances for day or night operations (FIGS. 8, 8, 9 and 10).

The method allows the user to apply an increasing “continuum of force” to; 1) illuminate the target and surrounding area to observe and determine behavior, 2) warn the target(s) by shining a non-disrupting beam of light from the device and illuminating them to attract their attention as a control, warning and contact technique, 3) increase the light beam and modulate the light beam output to distract and deter the targets as a low level compliance techniques and 4) increase the light beam output delivered to the target in either continuous or variable intensity to optical disrupt the target(s) at 0.1 to 12 lumen per square centimeter.

One aspect of the present invention is a method for interfering with or reducing the activity of one or more target individuals by over-stimulating their optic nerve. The method comprises the steps of providing a high intensity incoherent light beam emanating from an electrode-free plasma lamp housed within a device and directing the high intensity incoherent light beam at the one or more target individuals when he/she/they face or are tangential to the device.

In one embodiment of this aspect of the invention, the electrode-free plasma lamp produces a high intensity incoherent light beam in the range of 200 nm to 1,500 nm and has a plasma source diameter of less than or equal to 5 mm. Preferably the high intensity incoherent light beam frequency is about 300 nm to about 900 nm, about 380 nm to about 780 nm or about 510 nm to about 560 nm. The electrode-free plasma lamp may be selected from the group consisting of electrodeless light emitting plasma lamp, electrodeless high efficiency plasma lamp, electrode-free high intensity discharge lamp, electrode less laser-driven plasma lamp and electrode-free induction plasma lamp. The high intensity incoherent light beam is delivered to the one or more target individuals at about 0.1 to about 12 lumens per square centimeter and preferably from about 0.5 to about 12 lumens per square centimeter. The plasma source is equal to or less than 5 mm and is produced by plasma excited by electromagnetic waves selected from the group consisting of W laser light, x-ray radiation, gamma-ray radiation, microwave radiation and radio frequency waves. The electrode-free lamp is filled with a gas selected from the group consisting of xenon, argon, krypton, hydrogen, metal halides, sodium, mercury, and sulfur.

In another embodiment the output intensity of the high intensity incoherent light beam is adjusted on a random cycle or a fixed cycle. When adjusted to transmit in a random or fixed cycle the cycle output intensity may be increased and decreased less than 15 times per second. In yet another embodiment the method further comprises a step of filtering the high intensity incoherent light beam to reduce or remove frequencies below about 440 nm. In addition, the method may also comprise a step of determining the distance to the one or more targets and adjusting the high intensity incoherent light beam to achieve the desired lumens per square centimeter at the location of the one or more targets. In this embodiment, the ambient light at the one or more targets is determined and the high intensity incoherent light beam is adjusted to achieve the desired lumens per square centimeter at the location of the one or more targets.

In still other embodiments the electrode-free plasma lamp is filled with a gas, a volatile metal or a metal salt having reduced UV light emission.

In other embodiments, the one or more target individuals is/are one or more mammals, reptiles, or birds. Preferably the one or more mammals is/are one or more humans.

Another aspect of the present invention is an apparatus for interfering with or reducing the activity of one or more target individuals by over-stimulating the optic nerve. The device comprises an outer housing with a head portion having a window opening for transmitting a light beam, an optical system mounted in the head portion facing the window opening, one or more electrode-free lamps for emitting a high intensity incoherent light beam mounted at the focus of the optical system to collimate light towards the window opening and an electrical circuit means for driving one or more electrode-free lamps. The electrical circuit means having an energy source, a plasma lamp induction coupling(s) to the energy source(s) and controls for operation.

### Apparatus

The internal EFP lamp or induction light is a gas discharge lamp in which the power required to generate light is transferred from outside the lamp envelope to the gas inside via an electric or magnetic field, in contrast with a typical gas discharge lamp that uses internal electrodes connected to the power supply by conductors that pass through the lamp envelope. There are three advantages to elimination of the internal electrodes.

In the past, the reliability of the technology was limited by the magnetron used to generate the microwaves. Magnetron technology has improved providing longer life. Solid state RF generation can be used and give longer life. Using solid state chips to generate RF is more expensive currently than using a magnetron and so are appropriate for high value market niches. The RF signal generated by the solid-state RF driver is guided into an electric field about the bulb. The high concentration of energy in the M electric field vaporizes the contents of the bulb to a plasma state at the bulb's center. The controlled plasma generates an intense compact bright source of light that may be easily focused.

An EFP light source and generator of the present invention may be integrated into a housing and/or mounting and coupled with a battery for DC or direct AC source as may be appropriate for an application.

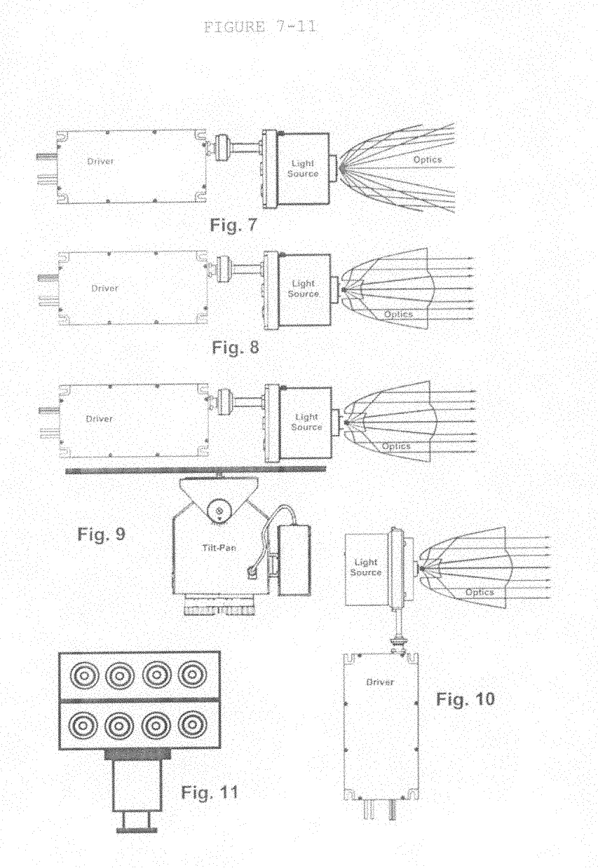

In one embodiment of a handheld device, a commercially available 280 W EFP light source and generator of the present invention may be integrated into a housing and mounting and coupled with a battery for DC or direct AC source as may be appropriate for a specific application. The EFP generator is configured with a parabolic reflector to provide a collimated diverging beam of light diverging at 1-degree or less included angle (see FIG. 7). In this embodiment, the device of the present invention consists of an EFP driver, plasma lamp, and associated optical components, a target ranging subsystem and battery, a power conversion and control electronics subsystem, and reflector. In this embodiment, the device produces between 1.4 and 10 lumens per square centimeter at the target providing “Optical Disruption” up to 150 ft in daylight and 500 ft at night with warning capability up to 1-mile.

Array of eight 1000 W EFP lamps mounted on a tilt pan as depicted in (FIG. 11) has the capability, with a highly collimated optics system, to optically disrupt at a range of 1-mile or more at night and 0.5 miles or more during daylight. This configuration illuminates and warns aggressors to the horizon.

In a preferred embodiment the device consists of an assemble of a 135 W Topanga APL250-4000 RF solid state Driver RF driver, coaxial connector cable, Topanga APL 250-4000SF resonator, and APL250-4000 plasma bulb, a quartz lamp embedded in a ceramics resonator, and associated micro-controller interface and powered with a lithium-ion 24-volt rechargeable battery capable of delivering a minimum of 10 amps (see FIG. 18). The RF coaxial cable exits the RF drive and is spiraled around the lens support which holds the optic lens positioned at the focus point of the plasma point source of light. The Optic lens (FIG. 13), designed by one of ordinary skill in the art, surrounds the face of the plasma light source, collecting and collimating the light, and is designed so that the light rays generally diverge at 0.5-degrees. The battery is located adjacent to the resonator and the RF driver, all of which are contained in a housing attached to the resonator. As can also be appreciated by one of ordinary skill in the art, a heat sink is attached to a resonator providing convection cooling to dissipate heat buildup and maintaining optimal operating temperatures for the resonator. Further a heat sink is attached to the RF driver providing convection cooling to dissipate heat buildup and maintaining optimal operating temperatures for the driver. And, the spectrum of the light is tailored by the fill chemistry inside the lamp envelop to provide a sun light like source output in the spectrum range of 380-780 nm. A UV filter is installed over the output beam in front of the optics to restrict 85% or more of UV emission below 440 nm for eye safety. All optics are coated with anti-reflective coatings to reduce light transmission loses. In manual mode the beam output can be set at 50% or 100%. When switched to automatic mode, the micro controller is programmed to vary the light level output from 20% up to 100% or more in a random pattern resulting in 1 to 7 light beam modulations per second thereby avoiding epileptic events.

FIG. 6 is a basic exemplar apparatus consist of a power source, either AC power to DC power supply or DC battery. The power supply or battery supplies power to the driver. The exemplar driver is a solid state RF amplifier. This commercially available driver has a resonator surrounding the EFP lamp. The commercially available exemplar RF amplifier is controlled by a micro-controller to manage light output intensity. The lamp envelope contains gases and may contain a low boiling point metal or mental halide. The highly concentrated electric field generated by the RF ionizes the gasses and vaporizes the metals or halides in the lamp—creating a plasma state emitting light from a single point.

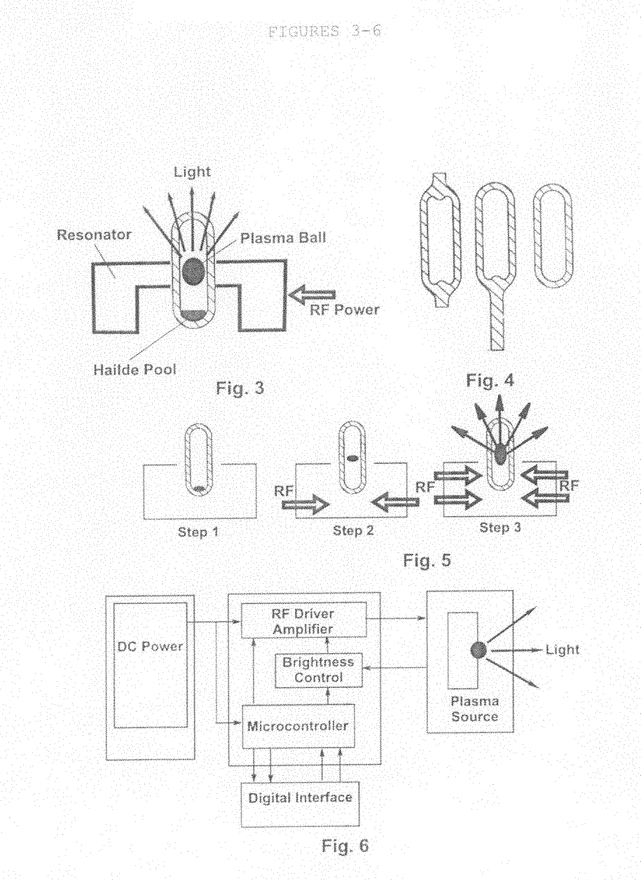

FIG. 3 depicts an EFP lamp centered in an RF resonator or microwave magnetron. Lamps may be positioned horizontally or vertically.

FIG. 4 shows different EFP lamp envelope configurations which may be used. Other designs may be used.

FIG. 5 depicts the EFP lamp startup sequence. Step 1 depicts first applying power to the wave driver amplifier generator, step 2 depicts wave energy being applied to the resonator or magnetron and step 3 depicts the excitation of the lamp fill to generate plasma and light.

FIG. 7 depicts an inline EFP lamp apparatus with driver, light source with a collimation parabolic reflector. While a small percentage of the light is not captured and is lost to scatter with this reflector configuration as a result of only using a reflector, the majority of the light is directed out the front window as nearly parallel rays and in the preferred embodiment diverges less than 1-degree. This is an improvement over short arc lamp designs that have a hole in the rear of the reflector and lose light in that orientation as well.

A further improved configuration FIG. 8 is an inline layout of an EFP lamp apparatus with collimation reflector and internal optics that can be used to capture virtually all the stray light that can be lost in the FIG. 7 optic configuration. This layout can lend itself to handheld configurations looking like portable “flashlights”.

FIG. 9 shows the embodiments of this invention mounted on tilt pan and roll devices for tracking and targeting aggressors. They can be automatically or manual aimed and combined with automated tracking technologies to follow prospective targets.

FIG. 10 is a right angle layout of an EFP lamp apparatus with collimation reflector and internal optics. This layout may lend itself to handheld configurations looking like portable “lanterns”.

FIG. 11 shows the EFP lamp apparatus as a single light or multiple light source device as depicted in FIG. 11 for greater deployment range for far away targets, and wider fields of engagement as may be needed for crowd control.

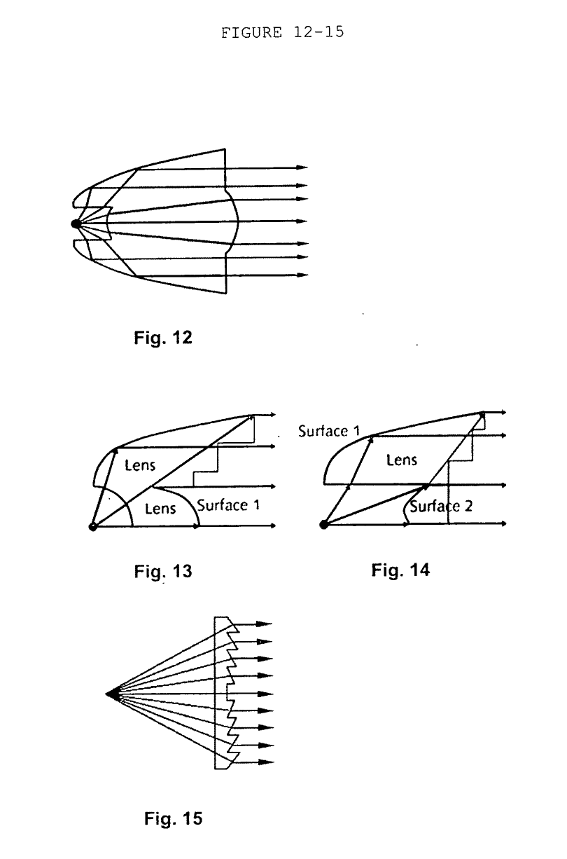

FIG. 12 is an exemplar of a parabolic reflector surface with an internally mounted refractive surface for collimation of the light source with minimal loss of stray light.

FIG. 13 is an exemplar refractor on the outside lens where the collimating lens has four types of surfaces for collimation of the light source with minimal loss of stray light.

FIG. 14 is an exemplar refractor on the inside where the collimating lens has four surface types for collimation of the light source with minimal loss of stray light

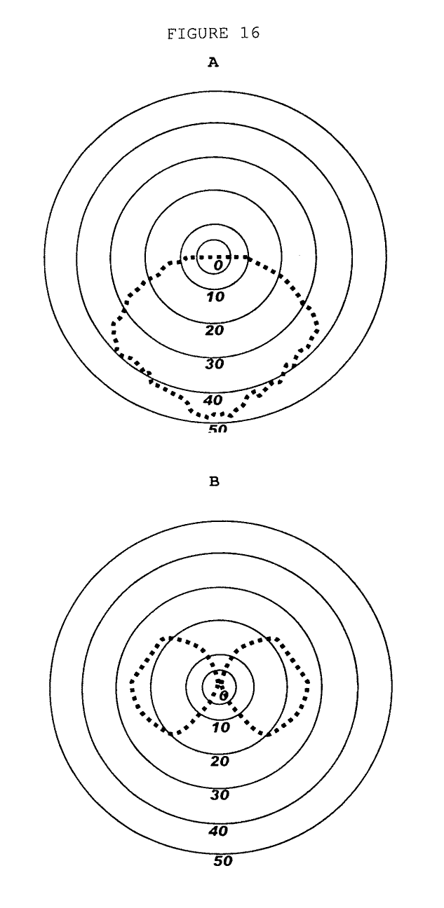

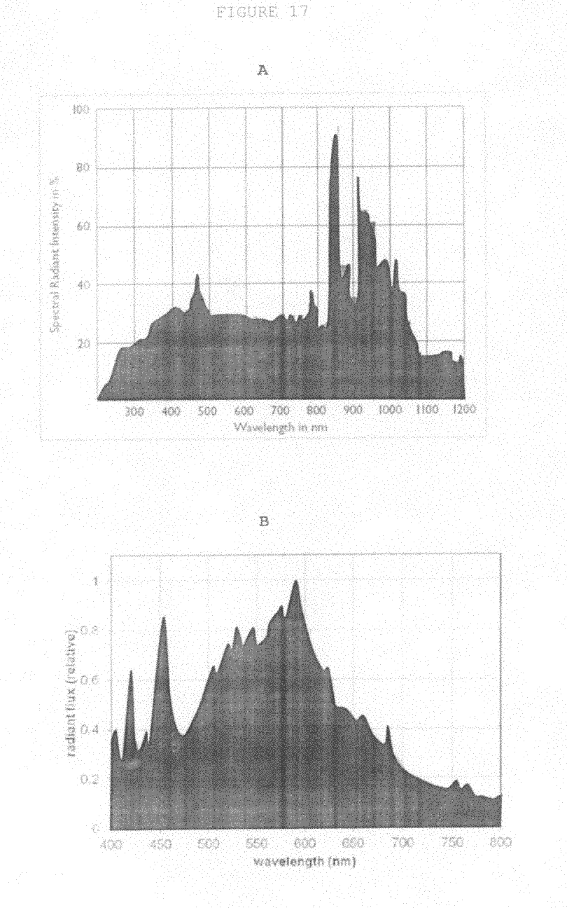

FIG. 15 is an exemplar Fresnel lens alone or in combination with a parabolic reflector as shown in FIG. 7 may be appropriate for collimation where weight or cost is a consideration.

### Operation

The exact mechanism for the optical disruption of mammals when exposed to burst of high levels of light goes beyond the temporary loss of vision that occurs. The optic nerve constitutes about 40% of the number of nerves entering or leaving the central nervous system via the cranial and spinal nerves and transports the majority of the neural information traveling to the visual cortex. The visual system also provides input for balance and muscle control.

This invention delivers luminance with sufficient photon content that, when applied to a target's eyes, it saturates the ocular retinal rods and cones producing a chemical induced electrical signal that surges through the optical nerve. It is postulated that a portion of the light optical disruption response may be subcortical and controlled via a pathway that bypasses the lateral geniculate body, optic radiations and visual cortex and goes directly to the superior colliculi. This pathway then relays to several brain stem and spinal nuclei via the tectobulbar and tectospinal pathways that initiate the motor response. The surge initiated in the neurons through all available pathways may explain the optical disruption as a function of a system wide sensory overload.

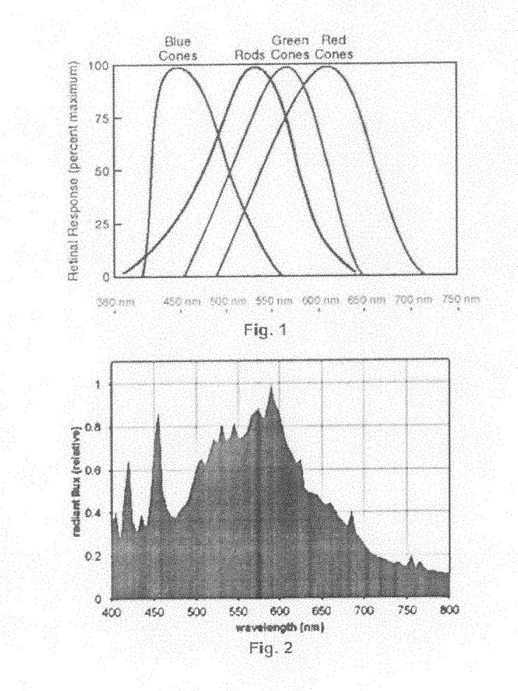

To be most effective for human applications, the optimal spectral frequency range delivered needs to cover all rods and cones receptor frequencies (see FIG. 1) within the eye for full rhodopsin saturation and electrochemical reaction through the neurons flooding the nervous system. For human optical disruption selecting a frequency centered about the range of 500 nm and 560 nm (see FIG. 1) is going to have the most effect in driving the electrical chemical rhodopsin reaction. For other animals a shift towards the blue/UV range or the red/IR range may be more effective given different animals optics.

For night use, a lower light intensity is initially required, but once the device is used and because the target's pupil re-dilation is not instantaneous, more beam intensity may be required for subsequent use on a target which intensity can be increased to the level normally needed during daylight conditions.

To address eye safety considerations, the preferred embodiment of this invention will be equipped with a blue/UV filter reducing exposure in this wavelength range. Incoherent light exposure risks studies referenced in the “Guidelines on Limits of Exposure to Incoherent Visible and Infrared Radiation” Health Phys. 105(1):74-96; 2013 International Commission on Non-Ionizing Radiation Protection are to be considered by the designer, as are the risk studies referenced in the “Guidelines on Limits of Exposure to Broad-Band Incoherent Optical Radiation (0.38 to 3 μm)” Health Physics 73 (3): 539-554; 1997 International Commission on Non-Ionizing Radiation Protection when determining the maximum light exposure in the design of embodiments of devices of this method. Those skilled in the art will recognize that the invention may be embodied or carried out in a manner that achieves one advantage or group of advantages as taught herein without necessarily achieving other advantages including safety considerations as may be taught or suggested herein.

It is known that physiological disorientation occurs in response to a flashing or strobe light source. This is reported to be caused by the attempt of the eye to respond to rapid changes in light level or color. For on-and-off flashing, the pupil of the eye is continually constricting and relaxing in response to the contrasting light intensity reaching the eye. Differing colors and intensities can cause the same effect. The disadvantage is that epileptic fits may result and permanent neurological damage has been reported. The National Society for Epilepsy states “Around one in two hundred people have epilepsy and of these people only 3-5% have seizures induced by flashing lights.” It is recommended that this issue be addressed in embodiments by restricting light intensity cycling rate frequency to less than 12 per second.

### Elements of Method and Apparatus Operation

The optical disruption effect of high intensity light is generally observed to occur within 1 second. The illuminated target is observed to temporarily lose the ability to see and to lose control of gross and fine motor skills and be optically disrupted for as long as the beam is applied to the target. optical disruption can take the form of one or more of the following observed responses, vision impairment, optical disruption, neural disruption, motor skill disruption, disorientation, vertigo, nausea, temporary blindness, night blindness, reducing cognitive abilities, loss of balance, psychophysical effects, vision loss, peripheral vision loss, disruption of fine and gross motor skills which can also be described as suppression, disabling, stunning, repelling, and dazzling.

### Optics Selection

In the preferred embodiment of the invention for a handheld device a lamp assembly is provided including an outer housing with a handle for gripping by a user, the housing having a window opening for transmitting a light beam, a parabolic reflector within the housing facing the window opening containing an optics system, an EFP lamp mounted at the focus of the parabolic reflector(s) via an adjustment and an optical system to collimate a beam of from an initial diameter diverging at 0.5 degrees (half angle) to the target.

Optically, EFP lamps are far more efficient at providing an even beam of light at the target not having to deal with artifacts, i.e. shadows, in the light beam projection resulting from cathode or anode terminals, the electrodes, wires in the light beam, and plasma ball distortion caused by the electrodes. Unlike arc-lamps and other electrode containing lamp technologies, where the electrodes expand and contract with heat and effect the plasma ball location in relationship to the focal point of the optics, and EFP lamps is not so effected. With an EFP lamp, the plasma ball is held in place by the lamp geometry and the excitation magnetic fields generated. Some examples of EFP lamps are provided below:

| MANUFACTURER | MODEL | WATTS | CRI | COLOR |
|---|---|---|---|---|
| Topanga USA, | APL 1000-5000 | 470 W | 70 | 5000K |
| Canoga, CA | APL 1000-4000 | 470 W | 80 | 4100K |
| | APL 400-5500 | 235 W | 70 | 5500K |
| | APL 400-4000 | 235 W | 80 | 4100K |
| | APL 250-5500 | 135 W | 70 | 5500K |
| | APL 250-4000 | 135 W | 80 | 4900K |
| Luxim Corp., | ENT-31-02 | 280 W | 94 | 5300K |
| Sunnyvale, CA | GRO-40 | 190 W | | 5200K |
| | GRO-41-02 | 270 W | | 5200K |
| | GRO-75-02 | 500 W | | 5200K |
| | LIFI-STA-40-01 | 280 W | 80 | 6000K |
| | LIFI-STA-40-02 | 280 W | 94 | 5300K |
| Ceravision Ltd., | custom | 300 W | | |
| Milton Keynes, UK | | to | | |
| | | 5000 W | | |

Various optical configurations may be embodied in an apparatus based on the application requirements and the engagement distance, from devices having no optics after the lamp except a UV filter for close in optical disruption engagement, to a combination of reflector, refractors, lens, anti-reflective (AR) coatings, and UV filter for long distance optical disruption engagements to collimate the light and deliver the specified luminance to the target. Light management optical systems may individually or in combination include:
a) a plasma source light back reflector focused back to the center of the plasma ball;
b) a parabolic reflector surface to collimate the light source;
c) a Fresnel lens;
d) a parabolic reflector surface with an internally mounted refractive surface such that virtually no light from the source can pass directly from the lamp without being reflected by the reflector or refracted by the center refractor;
e) a refractor on the outside lens where the collimating lens has four types of surfaces. The first surface has an aspheric profile and is designed to collimate light emitted from the EFP at smaller cone angles. The second surface is a parabola with the EFP at the focus and collects and collimates light from the EFP at large cone angles. The third surface is a spherical section near the EFP designed to pass rays into the lens at normal incidence to the surface. The fourth is a ladder surface, which minimizes lens weight, through which rays reflected from the parabolic surface exit without a change in direction;
f) a refractor on the inside where the collimating lens has four surface types. The first surface is a ladder-type flat surface; the second is an axial aspheric refractor; the third is an aspheric reflector; and the fourth is a cylindrical surface passing rays to the reflector;
g) a glass window;
h) an ultraviolet (UV) filter below 440 nm;
i) an anti-reflective surface coatings;
j) a light pipe, light tube, optical fiber, or light waveguide;
k) a Spherolit lenses or diffuser for flood light illumination; and/or
l) an infrared lens to block visible light for night surveillance;
   With no electrodes to interfere in the light travel, the optics designer is able to use virtually any optical configuration including Fresnel lens (see FIG. 12).

Because transmission with lenses is more efficient than reflection with reflectors, luminaries fitted with the appropriate lens systems deliver a better light output ratio. Alternative lenses could be exchanged simply to suit altered lighting performance tasks with the same basic apparatus.

If only IR illumination output is desired for long range night time surveillance, using night vision viewers with an IR filter located in front of the window may be added to the optical system to cut out visible light below 800 nm.

If a diffused flood is desired for use of the apparatus for near field board-area visual illumination, a diffuser or Spherolit lenses may be added to the optical system.

The optical system design and light transmission efficiency may be vary depending on configuration, optics quality, reflective and refractive loses and the desired design parameters including size, weight, and cost as will be appreciated by one skilled in the art.

### Lamp Selection

The EFP lamps are a type of gas discharge lamp energized by radio frequency or microwaves which energized light-emitting plasma in a bulb. The lamps may be built with different shapes and positioned vertically like the center and right-hand image in FIG. 4, or they may be placed horizontally using an envelope such as the right-hand or left-hand image in FIG. 4 and as depicted in FIG. 5. In addition to the manufacturers listed above, custom plasma lamp manufacturers include KYOCERA International, Inc. (San Diego, Calif.) and Rayotek Scientific Inc. (San Diego, Calif.).

In FIG. 5, a reflector may be installed on the back side of the lamp to redirect light to the front window and focus the light back through the plasma ball center (recycle the light). The energizing frequency and bulb fill can include gas, volatile metals and metal halides selected to produce the desire light wave length range for a given application. For human optical disruption, this range is 400 nm to 780 nm and centered about 510-560 nm (see FIG. 2). These lamps have minimal spectral changes with age and have 10,000 or more hours of life expectancy.

Bulb fill is selected based on desired spectral output for humans (see FIG. 1) or animals, luminous efficacy, color rendering, and other lamp properties that impact design and performance.

Applications where the apparatus design specifications include optical disruption and illumination, in both the visible and infrared emission range, as may be called for in military or law enforcement for a joint use apparatus, a xenon lamp fill may be selected. In this embodiment, since over 50% of the input energy will be used to generate infrared, the amount of visible light will be naturally lessened with a corresponding decrease in optical disruption range.

In one embodiment, the device comprises a EFP, with plasma ball (near ideal pinpoint light source) located at the focus of the reflector or optics, an electromagnetic wave RF generator energizing the plasma light source, and a cooling and heat sink mechanism for maintaining optimum W lamp temperature as desired.

### Range Finder and Light Meter Adjustable Lamp Intensity Control

Lamp power output is regulated by the amount of electromagnetic wave energy transmitted to the plasma light source. The preferred embodiment incorporates safety controls and associated light algorithms to manage light level output considering ambient light at the target as indicative of likely pupil size, luminance for illumination, warning and optical disruption and considering safety.

In the preferred embodiment the power control level the plasma exciter is modulated to increasing and decrease the total luminance to optically disrupt one of more targeted individuals within a duration of less than 1 seconds.

A commercially available IR-based range finder and light meter may be interfaced with the electronic power control of the device's plasma generator to regulate the amount of light delivery to the target, increasing its safety.

### Accessories

Mounting points, such as Picatinny rail and ¼-20 tripod mounts may be added to the apparatus to allow easy connections to a recording camera. Other accessories include a tilt-pan, laser pointer for day and night targeting, IR/Far IR/thermal viewer for night time targeting, handles and/or carry straps.

### Battery

Low battery fuel gauge indicator mounted in the housing or on the battery is preferred when operating on battery power. The embodiment may have the battery contained within the apparatus housing, attached to the housing, or externally mounted with a belt clip or connected to a vehicle's battery.

### Thermal Management

The apparatus may use conduction and convections cooling technologies to achieve the desired lamp operating temperature and pressure. A steady lamp envelope temperature, determined by the selected lamp fill chemistry, is desirable to achieve optimal light output characteristics. In one embodiment, an argon gas and mercury halide filled quartz lamp operates at a temperature of about 800° C. Alternative lamp fill chemistry can require sapphire lamps for better corrosion resistance and higher operating temperatures.

The plasma lamp envelope and contents are preheated to elevate gas temperature and vaporize lamp fill materials, to shorten lamp and plasma generation startup times using a heat source from the group consisting of conduction, convection, advection, radiation, and induction heating. To pre-heat the lamp gas and boil the metal or metal halides, one preferred embodiment uses an IR laser diode or the RF or Microwave energy of the primary resonation in a low power simmer mode prior to full application of the needed plasma excitement energy level.

### Housing Configurations

Example configurations are shown in FIGS. 7, 8, 9, 10 and 11. The optimal configuration for handheld, vehicle mounted, ship mounted and stationary mounted and the use of arrays and motion control devices such as tilt-pans can vary based on the design requirements. Since the invention can utilize any size lamp and can be scaled from one to many in an array of unlimited size, sizes of 100,000 W and more are possible. Those skilled in the art will recognize that the invention may be embodied or carried out in a manner that achieves one advantage or group of advantages as taught herein without necessarily achieving other advantages as may be taught or suggested herein.

### EFP Lamp Advantages

### 1. Extended Lamp Life

EFP lamp life is extended from 500 to 1,000 hours for short arc lamps to over 10,000 hours with EFP lamps of the preferred embodiment. In general, internal electrodes are the limiting factor in lamp life due to erosion, and unwanted metal deposits on the inside of the lamp envelope which degrades light output, changes the focal point and results in increased plasma ball size all to the determent of the amount of light being delivery to the target as the lamps containing electrodes age. Further, as the electrodes wear the light source ball can no longer be consider a point source, as it grows in size, with lessening intensity and is less concentrated, negatively impacting the amount of projected light from the optics. This significantly reduces device maintenance cost for EFP Lamp devices over the lifetime of the device.

### 2. More Flexible Lamp Chemistry

EFP lamps provide flexibility in selection of lamp fill chemistry, since chemical interaction with the electrodes or seals are eliminated. This allows the W designer of devices of this method the opportunity to tailor spectral output to optimize performance for specific targets, i.e. humans, dogs, cats, alligators, etc. More specifically, the lamp envelope may be built from various chemical resistant materials such as sapphire to allow for a variety of gas, volatile metal, or metal halide chemistries that may more easily be changed to provide the desired spectral output for different applications and for dual uses, such as IR illumination.

EFP lamps are highly efficient and produce 60 to 150 lumens per Watt or more, reducing the amount of power (battery size) needed, by a factor of 4 to 10, to deliver the same optical disruption capability as a short-arc lamp. In addition, EFP lamp source has an order of magnitude higher lumen density (amount of light from one device) as compared to short arc lamps.

### 3. Resistant to Impact Damage

The EFP lamps are more resistant to G-forces due to their smaller size and mass and therefore allow the designer the capability to design a more compact housing and optic system. The small source also allows the luminaire to utilize more than 90% of the available light compared with 55% for typical HID fittings.

### 4. Greater Output Efficiency

With efficiencies and lifetimes on par with LEDs, EFP lamp apparatuses can be designed to have much better light concentration from a small plasma ball and therefore better collimation and focusing capability than LED and HID EFP light for illumination and optical disruption, is a technology which exceeds that of short-arc lamp technologies in light projection to a target with significant lamp life increases on par with LED. EFP Light is a solid state high intensity light source that brings efficient lighting solutions to non-lethal optical disruption. It is energy efficient, long lasting, full spectrum and brighter than other lighting technologies at the target.

### 5. Reduced Cost

Costs for low powered and short range devices are relatively low compared to other technologies. IN particular, an EFP source offers lower lifetime cost with savings in energy and maintenance that result in a great return on investment and lower total cost of ownership.

### 6. Superior Optical System Collimation

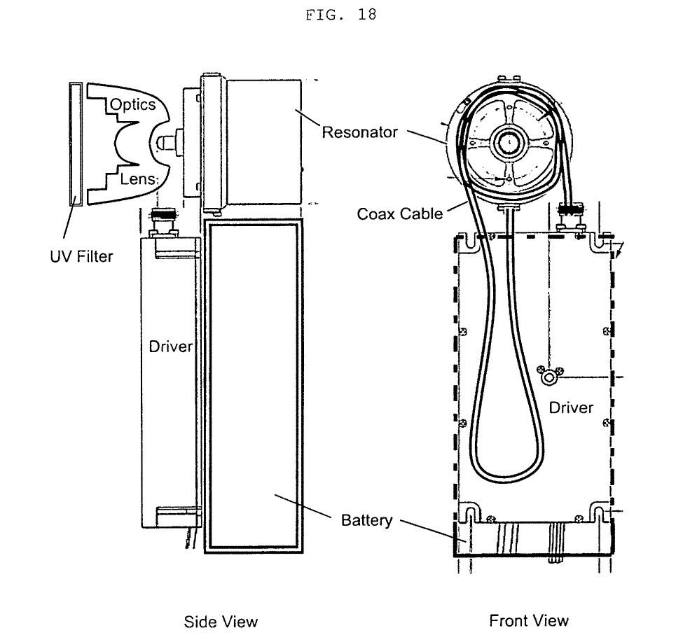

EFP lamps have no shadows or artifacts in the light beam path (i.e., eliminates the “Black Hole”) as demonstrated by FIGS. 16 (A) and (B).

FIG. 16 (A) depicts the light pattern of an EFP lamp showing a tight plasma ball, a point of light which emits all light in the direction of projection. FIG. 16 (B) depicts a typical short arc lamp, which emits a light pattern with a black hole or shadow in the direction of the lamp's length.

Unlike short arc lamps (FIG. 16 (B)), EFP lamps have no optical obstructions between the plasma source and target. The EFP lamp generates a nearly perfect point source of light. This provides the designer the ability to use a reflector and optical lenses to collimate and shape the light beam because there is no cathode or anode wire shadows, lamp shadows, no electrodes, wires or artifacts in the light beam path which is not practical with short arc lamps. Those skilled in the art will understand the design implications of eliminating the “black hole”.

The smaller tighter and more spherical nature of the EFP ball light source significantly enhances the collimation design capability of optical systems, creating longer range higher intensity beams.

### 7. Compact

The small size of the EFP lamp makes for more compact devices and allows the positioning of optics closer to the plasma ball source, see Table 1.

TABLE 1

| Short Arc Lamp Bulb | EFP Lamp Bulb |
|---|---|
| 75 W = 90 mm × 13 mm | 135 W = 20 mm × 10 mm dia. |
| 300 W = 175 mm × 25 mm | 235 W = 20 mm × 10 mm dia. |
| 500 W = 234 mm × 29 mm | 470 W = 20 mm × 10 mm dia. |

### 8. Superior Light Source Position

Five out of Six short Arc lamps are manufactured with the electrode sufficiently off axis resulting in loss of light available for collimation when using a reflector or they requiring fine positioning adjustment to center the electrodes to the desired focal point. With EFP lamps, the plasma ball is automatically centered due to the centering physics of the Microwave magnetron or RF resonator.

### 9. Efficient Light Output

As can be observed, for the same amount of power used on a 150 W xenon short arc lamp, the EFP lamp will generate 3 to 4 times as much light, see Table 2. Alternatively, for the same luminous output, the EFP lamp power consumption is approximately ⅓ of that of the short arc lamp. Besides energy saving, for portable battery applications, this significantly lower power consumption equates to small battery capacity needs, reduced battery size and lighter weight, a critical design concern for military and law enforcement devices.

TABLE 2

| Short Arc Lamp | EFP Lamp |
|---|---|
| 150 W = 2,700 lm | 135 W = 10,500 lm |
| | 235 W = 21,000 lm |
| 500 W = 16,000 lm | 470 W = 44,000 lm |

Because the energy conversion of an EFP lamp is 75 lumens per Watt or better combined with other optical advantages, greater optical disruption distances can be achieved with an appliance of the same size and weight, allowing as much as ten times greater distance target optical disruption capability for the same power consumption and apparatus package size as compared to a device using a short arc lamp.

### 10. Superior Turndown Ratio

EFP lamp outputs can be cut to 20% of rated output, whereas short arc lamps can only be turned down to 50% of their rated output. This gives the user and designer much more operational flexibility when using the EFP lamp.

### 11. Optimal Spectral Output

The spectral range for the human eye is approximately 380-750 nm. As can be seen in the spectral graphs above (FIG. 17), a xenon short arc lamp produces significant amount of energy in the infrared range, which are not useful for over-stimulating the optic nerve. Therefore, the preferred metal halide EFP lamp in FIG. 17 is more efficient, wasting less energy.

### 12. Minimized Thermal Management

The selection of the appropriate metal halide gas filled EFP lamps does not generate significant amounts of infrared energy, so there is much less heat to dissipate, minimizing thermal management cooling requirements compared to short arc lamps. Thermal management heat dissipation for EFP lamp designs can be accomplished with simple convection finned heat sinks compared to forced air cooling required for short arc lamps.

### 13. Easily Managed Electromagnetic Interference (EMI)

Short arc lamps generate electromagnetic waves from the arc lamp electrodes from the igniter during ignition and from the initial spark across the electrodes. Short arc lamps require extensive shielding and with shielding will emit unwanted EMI in the direction of the light beam. EMI from a EFP lamps is easier to control by using the microprocessor to spread the frequencies over a range to reduce EMI and comply with EMI regulations.

### 14. Modulated (Dimmer Approach) Light Output

Eisenberg teaches the use of an electronic pulse to momentarily increase light output from a short arc lamp. This increased current to the electrode has the disadvantage of increasing electrode wear, i.e. erosion, dramatically decreasing lamp life and increase the probability of metal deposits on the inside of the lamp envelope obscuring the light intensity and light quality generated. An EFP lamp driven by RF does not have this problem as there is no electrode to erode and a pulse is not required to achieve modulation of the beam intensity.

### Use

### RF Modes of Operation:

1) Connect device to battery not external power source
2) EFP lamp startup sequence steps:
a. engage power off/on-warmup switch;
b. initiate “warmup mode” RF by applying power to the RF wave driver amplifier generator;
c. select day or night operations (manual selection or light meter and distance determined if desired, to determine beam intensity);
d. apply initial wave energy to the RF resonator; and
e. increase RF wave energy to excite the lamp fill to generate the plasma light source.
3) Modulate the RF wave to increase and decrease the plasma light source intensity to effect the optical disruption sought (preprogrammed or based on target distance and light level calculated).
4) Aim the device at the target's eyes.
5) Monitor battery fuel gauge as necessary.

Although the foregoing invention has been described in terms of certain embodiments and examples, other embodiments will be apparent to those of ordinary skill in the art from the disclosure herein. Moreover, the described embodiments have been presented by way of example only, and are not intended to limit the scope of the inventions. Indeed, the novel methods and systems described herein may be embodied in a variety of other forms without departing from the spirit thereof. Accordingly, other combinations, omissions, substitutions and modifications will be apparent to the skilled artisan in view of the disclosure herein. Thus, the present invention is not intended to be limited by the example or preferred embodiments. The accompanying claims provide exemplary claims and their equivalents are intended to cover forms or modifications as would fall within the scope and spirit of the inventions.

### SEQUENCE LISTING

Not applicable

What is claimed is:

1. A method for interfering with or reducing the activity of one or more target individuals by over-stimulating the optic nerve of said target individuals said method comprising the steps of:
providing a high intensity incoherent light beam emanating from an electrode-free plasma lamp housed within a device; and
directing said high intensity incoherent light beam at said one or more target individuals when said target individuals face or are tangential to said device, thereby over-stimulating the optic nerve of said target individuals and interfering with or reducing said target individuals activity.

2. The method according to claim 1, wherein said electrode-free plasma lamp produces a high intensity incoherent light beam in the range of 200 nm to 1,500 nm.

3. The method according to claim 1, wherein the electrode-free plasma lamp is selected from the group consisting of electrodeless light emitting plasma lamp, electrodeless high efficiency plasma lamp, electrode-free high intensity discharge lamp, electrode less laser-driven plasma lamp and electrode-free induction plasma lamp.

4. The method according to claim 1, wherein said high intensity incoherent light beam is produced from a plasma source having a diameter of less than or equal to 5 mm.

5. The method according to claim 1, wherein said high intensity incoherent light beam is delivered to said one or more target individuals at about 0.1 to about 12 lumens per square centimeter.

6. The method according to claim 1, wherein said high intensity incoherent light beam is delivered to said one or more target individuals at about 0.5 to about 12 lumens per square centimeter.

7. The method according to claim 1, wherein said high intensity incoherent light beam frequency is about 380 nm to about 780 nm.

8. The method according to claim 1, wherein said high intensity incoherent light beam frequency is about 510 nm to about 560 nm.

9. The method according to claim 1, wherein said high intensity incoherent light beam frequency is about 300 nm to about 900 nm.

10. The method according to claim 1, wherein said high intensity incoherent light beam is produced by plasma excited by electromagnetic waves selected from the group consisting of laser light, x-ray radiation, gamma-ray radiation, microwave radiation and radio frequency waves.

11. The method according to claim 1, wherein said electrode-free lamp is filled with a gas selected from the group consisting of xenon, argon, krypton, hydrogen, metal halides, sodium, mercury, and sulfur.

12. The method according to claim 1, wherein the output intensity of said high intensity incoherent light beam is adjusted on a random cycle or a fixed cycle.

13. The method according to claim 12, wherein said output intensity is increased and decreased less than 15 times per second.

14. The method according to claim 1, further comprising a step of filtering said high intensity incoherent light beam to reduce or remove frequencies below about 440 nm.

15. The method according to claim 1, wherein said electrode-free plasma lamp is filled with a gas, a volatile metal or a metal salt having reduced UV light emission.

16. The method according to claim 1, further comprising a step of determining the distance to said one or more targets and adjusting said high intensity incoherent light beam to achieve the desired lumens per square centimeter at said one or more targets.

17. The method according to claim 1, further comprising a step of determining the ambient light at said one or more targets and adjusting said high intensity incoherent light beam to achieve the desired lumens per square centimeter at said one or more targets.

18. A method according to claim 1, wherein said one or more target individuals are one or more mammals, reptiles, birds or fishes.

19. A method according to claim 18, wherein said one or more mammals are one or more humans.

20. An apparatus for interfering with or reducing the activity of one or more target individuals by over-stimulating the optic nerve of said target individuals said device comprising:
an outer housing with a head portion having a window opening for transmitting a light beam;
an optical system mounted in said head portion facing said window opening;
one or more electrode-free lamps for emitting a high intensity incoherent light beam mounted at the focus of said optical system to collimate light towards the window opening;
an electrical circuit means for driving one or more electrode-free lamps; wherein said electrical circuit having an energy source, a plasma lamp induction coupling(s) to said energy source(s) and controls for operation.
